(19) United States
(12) Patent Application Publication
(10) Pub. No.: US 2025/0354811 A1
(43) Pub. Date: Nov. 20, 2025

(54) LOCALISATION SYSTEM

(71) Applicant: ARWAIN SYSTEMS LTD, Welshpool Powys (GB)

(72) Inventors: Colin Adrian BRODERICK, Oswestry Shropshire (GB); Chris MURRAY, Oxford Oxfordshire (GB); Ryan Lee COWLEY, Banbury Oxfordshire (GB)

(73) Assignee: ARWAIN SYSTEMS LTD, Welshpool Powys (GB)

(21) Appl. No.: 19/284,075

(22) Filed: Jul. 29, 2025

Related U.S. Application Data
(63) Continuation of application No. PCT/GB2023/053333, filed on Dec. 20, 2023.

(30) Foreign Application Priority Data
Jan. 30, 2023 (GB) 2301300.6

(51) Int. Cl. G01C 21/16

(52) U.S. Cl. CPC G01C 21/1652

(57) ABSTRACT

A localisation device having a first sensor that is configured to provide first measurement data and a neural processing unit (NPU) that includes a pre-trained artificial neural network (ANN) and a processor that is in communication with the first sensor and the NPU. The processor is configured to collect the first measurement data from the first sensor over a time period and determine a real-world location using the ANN.

### CROSS REFERENCE TO RELATED APPLICATIONS

This continuation application claims priority benefit from International Application No. PCT/GB2023/053333 filed on Dec. 20, 2023, which claimed priority from Great Britain Application No. 2301300.6 filed Jan. 30, 2023, which are both incorporated herein by reference in their entirety.

### FIELD OF THE INVENTION

The present disclosure relates to a system for localising entities, and finds particular use in the localisation of pedestrians in, for example, a GPS-denied environment.

### BACKGROUND OF THE INVENTION

Localisation of objects or people may be achieved through several different means. For example, global positioning systems (GPS), visual odometry, and beacon-based localization systems may all be used to determine a location of an object or person. Further localisation systems will be known by the skilled person.

A global position system (GPS) receiver determines a position based on data received from multiple GPS satellites. However, GPS systems may lack precision or fail entirely inside areas such as buildings, forests, and underground locations. This failure may be due to a blockage of a signal comprising the data from the GPS satellites.

Visual odometry is the process of determining the position and orientation of an object or person based on an analysis of captured images. However, visual odometry systems may only operate in ideal conditions, and may require expensive equipment, such as image capturing devices, to function.

Traditional beacon-based localization systems are typically permanent installations and may be time-consuming to install. They may also require power and radio infrastructure to be present at the installation location. Accordingly, these beacon-based localization systems may rely on existing infrastructure to localize a pedestrian.

The present disclosure has been devised to mitigate at least some of the above-mentioned problems.

### SUMMARY OF THE INVENTION

The present disclosure is directed toward a localisation device used in the localisation of pedestrians, although it will be appreciated that the device may be used in any suitable context. In use with pedestrians, the device may be worn as a body-worn device, such that all sensors and computing resources are present on the pedestrian.

In one aspect of the present disclosure provided herein, the localisation device includes a first sensor configured to provide first measurement data with a neural processing unit (NPU) comprising a pre-trained artificial neural network (ANN); and a processor in communication with the first sensor and the NPU. The processor is configured to collect the first measurement data from the first sensor over a time period; and determine a real-world location using the ANN is an alignment guide system. The system including a first translation mechanism, a second translation mechanism coupled to the first translation mechanism, and a third translation mechanism coupled to the second translation mechanism.

### BRIEF DESCRIPTION OF THE DRAWINGS

The accompanying drawings, which are incorporated in and constitute a part of the specification, illustrate embodiments of the disclosure and together with the detailed description herein, serve to explain the principles of the disclosure. It is emphasized that, in accordance with the standard practice in the industry, various features are not drawn to scale. In fact, the dimensions of the various features may be arbitrarily increased or reduced for clarity of discussion. The drawings are only for purposes of illustrating preferred embodiments and are not to be construed as limiting the disclosure:

FIG. 1 shows a systematic view of a position tracking device, in accordance with an aspect of the present disclosure;

FIG. 2 shows a flow diagram of a position tracking method using the position tracking device of FIG. 1, in accordance with an aspect of the present disclosure;

FIG. 3 shows a flow diagram of a stance determination method using the position tracking device of FIG. 1, in accordance with an aspect of the present disclosure; and

FIG. 4 shows a systematic view of a position tracking system comprising the position tracking device of FIG. 1 in communication with a network of nodes, in accordance with an aspect of the present disclosure.

### DETAILED DESCRIPTION FOR CARRYING OUT THE INVENTION

In accordance with a first aspect of the present disclosure, there is provided a localisation device comprising: a first sensor configured to provide first measurement data; a neural processing unit (NPU) comprising a pre-trained artificial neural network (ANN); and a processor in communication with the first sensor and the NPU, the processor configured to: collect first measurement data from the first sensor over a time period; and determine a real-world location using the ANN.

The device of the present disclosure is preferably used in the localisation of pedestrians, although it will be appreciated that the device may be used in any suitable context. In use with pedestrians, the device may be worn as a body-worn device, such that all sensors and computing resources are present on the pedestrian. Advantageously, the use of the NPU may provide a means for feasibly running the ANN on the body-worn device, whereas a non-specialised processor may be too slow and may consume too much power.

Furthermore, the device may be a body-worn device which captures environmental data, processes the environmental data using the ANN, and creates state predictions in real-time. Accordingly, the device of the present disclosure may provide a means for accurate pedestrian localisation in three-dimensional (3D) space, or real-world location, using a body-worn device.

Advantageously, the device may require no pre-existing infrastructure to determine the location of the pedestrian. Further advantageously, the present device may operate in any environment. Further advantageously, the device may be robust to interference or deception. Further advantageously, the device may be constructed of readily-available equipment. Further advantageously, the device may be of minimal size and weight. Further advantageously, the device may not require mounting to feet, or personal protective equipment (PPE) integration. Further advantageously, the device may not rely on inaccurate step counting. Further advantageously, the device may be rapidly deployable. Further advantageously, the device may have no requirement for prior mapping or floorplans.

In preferable embodiments, the first sensor is an inertial measurement unit (IMU) comprising an accelerometer and a gyroscope, the IMU being configured to measure an acceleration and an angular velocity; and the first measurement data comprises: acceleration data; and angular velocity data. In this way, the real-world location of the pedestrian may be determined using an IMU. Advantageously, the present device may provide a means for accurate localization of pedestrians in GPS-denied environments, such as buildings, forests, and underground areas. Further advantageously, the present device may provide an accurate real-world location with minimal space usage, and a reduced cost of equipment.

In some embodiments, the processor determines the real-world location by: rotating the first measurement data into a world coordinate frame; inputting the rotated first measurement data into the ANN; receiving an average velocity of the time period from the ANN; and converting the average velocity to a real-world location. The average velocity may be converted to a real-world location via integration. In this way, the present device may determine the real-world location of the pedestrian with a minimal computational expense.

The real-world location may be relative to a starting position. In this way, the present device may determine the real-world location of a pedestrian in GPS-denied environments based on the data measured by the first sensor. In some embodiments, the starting position may be the most recent position provided by a GPS, or other localization means. In other embodiments, the starting position may be assigned an origin coordinate of (0, 0, 0), and other positions and/or locations are determined relative to the origin coordinate. In yet other embodiments, the starting position may be determined via a user interface, in which the user manually inputs a starting position. The user interface may comprise a mapping interface comprising coordinate locations that are selectable by the user.

In some embodiments, the device further comprises a second sensor configured to measure a pressure and a temperature, wherein the processor is further configured to: receive pressure data and temperature data from the second sensor; determine an altitude value based on the pressure data and the temperature data; and modify a vertical component of the real-world location based on the altitude value. In this way, the vertical component of the real-world location may be supplemented by data received from the second sensor, which provides a direct measure of altitude. Advantageously, an accuracy of the vertical component of the real-world value may be increased.

In some embodiments, the altitude value is determined using a hypsometric formula. In this way, the altitude value may be directly computed from the pressure data and the temperature data. Advantageously, a computational expense may be reduced.

In some embodiments, the processor is further configured to determine a stance of a wearer based on the first measurement data. The term “stance” may refer to a mode of movement of the pedestrian. Example stances include, but are not limited to, walking, crawling, standing, running, and climbing. In this way, information about the mode of movement of the pedestrian may be determined. Advantageously, more useful information may be provided by the device.

In some embodiments, the processor is configured to determine the stance of the wearer based on first measurement data captured over a stance time period. In particular, the processer may be configured to determine the stance of the wearer based on: an average velocity over a preceding period; an average acceleration of a preceding period; an average rotation over a preceding period; and a device orientation and attitude in the world coordinate frame. The stance time period may be, for example, 1 second in length. The average velocity may be determined using the ANN. The average acceleration may be determined using the acceleration data. The average rotation may be determined using the angular velocity data. The device orientation and attitude may be determined using the angular velocity data and the acceleration data.

In some embodiments, the processor is further configured to determine activity information of a wearer based on the first measurement data. The term “activity information” or activity intensity may refer to a measure of how dynamic a motion of a wearer is. A highly dynamic motion, or a high activity intensity, may occur when there is a high acceleration or angular velocity with no significant forward spatial progress. A high activity intensity may indicate, for example, a wearer being trapped and struggling to escape, or a wearer actively searching small compartments such as a closet. Accordingly, the device may advantageously provide information indicative of whether a pedestrian is in danger.

The activity information may additionally or alternatively be used for detecting unspecified and potentially adverse circumstances for a wearer. For example, a freefall event may be determined when an average acceleration for a time period exceeds an acceleration threshold, which may be indicative of a wearer accelerating in a manner that is unsafe. Accordingly, the device may advantageously provide information indicative of whether a pedestrian is in danger. For example, if a freefall event is determined to have occurred, this may indicate that the pedestrian has fallen a significant distance and may be injured.

Accordingly, the device of the present disclosure may be a body-worn device which captures environmental data, processes the environmental data using the ANN, and creates state predictions in real-time. ‘Environment data’ may refer to any type of environmental sensor data, and ‘state prediction’ may refer to states of a wearer other than location.

In some embodiments, the processor is configured to determine the activity information of the wearer based on first measurement data captured over an activity time period. The activity time period may be, for example, 100 milliseconds in length. The average velocity may be determined using the ANN. The average acceleration may be determined using the acceleration data. The average rotation may be determined using the angular velocity data. The device orientation and attitude may be determined using the angular velocity data.

In some embodiments, the processor is further configured to: detect a stationary state of the wearer; and adjust a bias calibration parameter of the gyroscope. The term ‘bias calibration parameter’ may refer to a situation wherein the gyroscope provides a non-zero angular velocity reading despite being stationary, for example due to intrinsic errors of the sensor itself. When the processor determines that the gyroscope is stationary, the unmodified readings from the gyroscope may be the bias calibration parameter. The bias calibration parameter may be subtracted from all readings before being used for any processing. The system may therefore advantageously mitigate the effects of heading angle drift of the gyroscope over time, and the modified readings of the gyroscope may be a more true measure of the actual motion of the device. In particular, the gyroscope calibration may be as recent as possible when a use of the system begins. Furthermore, the wearer may not need to perform a manual calibration of the gyroscope. Preferably, the processor is configured to disengage the automatic calibration when the wearer begins moving whilst wearing the system.

Preferably, the processor is configured to utilise an exponentially-weighted moving average (EWMA) to adjust the bias calibration parameter of the gyroscope. Advantageously, use of an EWMA may suppress noise spikes and allows only very slow adjustments of the bias, whilst ensuring that old data samples are eventually ‘forgotten’, as gyroscope bias can change over time.

In preferable embodiments, the process is further configured to transfer data to a remote server via a communication means. In particular, real-world position, stance, and activity information metadata may be communicated to the remote server using a low power long range radio. The metadata may be communicated according to a data transmission protocol, wherein the data is transmitted at 10 bytes per second. Six bytes may be reserved for position information, wherein each ordinate is encoded as a 16-bit integer, with the remainder being stance metadata, activity metadata, identification codes, and space for future growth. In this way, information may be provided to a remote location, which may be accessed by a user. Advantageously, a user may deduce a location and/or stance of a pedestrian based on the data transferred to the remote server.

In some embodiments, the ANN is trained using ground truth data comprising 3D position data. In some embodiments, the 3D position data is captured via image capture. However, it will be appreciated that further means for capturing the 3D position data may be envisaged. In this way, the ANN may be trained with reliable data.

The data which is used to provide training may be acquired by live image processing means, but the image data itself may not be used for training of the ANN. The image data may not be stored beyond the instant in which it generates training data. In principle, this training data may be acquired by other means. A binocular camera may be used to determine a position using processing means of a camera module. The camera module may be configured to transmit position information, and other quality metrics, and may optionally transmit image data.

In accordance with a second aspect of the present disclosure, there is provided a localisation system comprising: the device of the first aspect of the present disclosure; a network of nodes comprising one or more processors; wherein the device is a node of the network of nodes; and wherein the network of nodes is configured to generate a node map.

Each node in the network of nodes may serve as a distributed compute resource and may store a copy of the node map. In this way, the network of nodes may be more resilient and may allow for redundancy in nodes. Advantageously, the network of nodes may be tolerant to nodes having a weak or lost connection. One or more nodes may be manually controlled, for example by means of a supported platform by USB.

The network of nodes preferably provides short-lived and low-cost beacon-based localization. The nodes may be placed anywhere, for example fixed to walls, or placed on table tops and shelves. In this way, the network of nodes may not be a permanent installation and may require less time to install. Furthermore, the network of nodes may require less power and/or radio infrastructure at an installation location.

The device being a node of the network of nodes may advantageously provide a means for improving a real-world position estimation, and may also provide a means for eliminating errors in velocity estimation and heading estimation.

Preferably, the network of nodes generate the node map via an iterative process that updates in real-time. In particular, the nodes may automatically measure a pairwise range between each pair of nodes, and a map may be created of the relative locations of the nodes. Preferably, the network of nodes does not comprise any special nodes. For example, the network of nodes may comprise no distinction between anchor nodes or tag nodes. In this way, one or more nodes, including the body-worn device, may be moved at any time, and the node map may be updated in real-time in response.

In some embodiments, the node map is modelled as a damped, fully-connected spring network, wherein the node map is initially modelled by assigning each node a random geographical location. In this way, the node map may evolve to express the real-world locations of the nodes in the network of nodes.

In some embodiments, the node map is updated when a new node connects to the network of nodes.

In some embodiments, the processor is configured to: determine that the device is within a communication range of a node of the network of nodes; determine a distance between the device and the node; estimate a distance between the device and the node using the first sensor; determine a heading angle error of the gyroscope based on the determined distance and the estimated distance; and alter the heading angle of the gyroscope by removing the heading angle error. In this way, the heading angle of the gyroscope may be corrected using the network of nodes.

In some embodiments, the processor determines a distance between the device and the node using an ultra-wideband radio communication means.

It will be appreciated that any features described herein as being suitable for incorporation into one or more aspects or embodiments of the present disclosure are intended to be generalizable across any and all aspects and embodiments of the present disclosure. Other aspects of the present disclosure can be understood by those skilled in the art in light of the description, the claims, and the drawings of the present disclosure. The foregoing general description and the following detailed description are exemplary and explanatory only and are not restrictive of the claims.

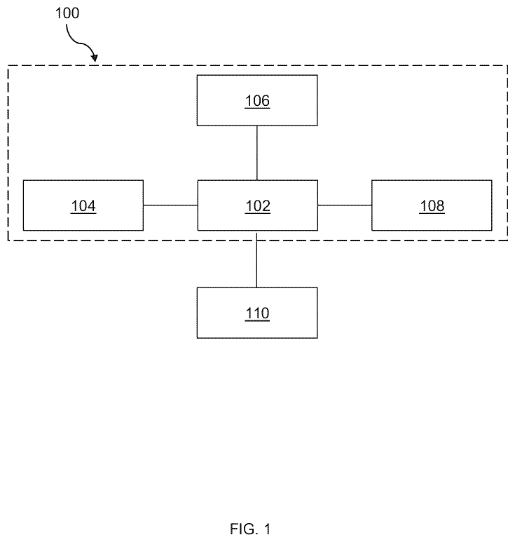

FIG. 1 shows a systematic view of a position tracking device 100 in accordance with a first aspect of the present disclosure.

The position tracking device 100 is configured to track a real-world position of an object, human, or the like, in three-dimensional (3D) space. In use with a human or the like, components of the position tracking device 100 may be worn. The position tracking device 100 utilises a pre-trained artificial neural network (ANN) to estimate the position in 3D space.

The following example of the position tracking device 100 will be described in use with a human, or wearer.

The position tracking device 100 comprises a processor 102, an inertial measurement unit (IMU) 104, an optional second sensor 106, and a neural processing unit 108 comprising an artificial neural network (ANN).

The position tracking device 100 of the present example is configured to be worn by the wearer.

The processor 102 is in communication with the other components of the position tracking device 100, and is configured to execute various functions of the components. The processor 102 is also configured to collect or receive data from the components, and perform operations on the data. The processor 102 is also configured to provide data to the ANN. The processor 102 comprises, or is in communication with, various components, such as a memory (not shown), a transmitter (not shown), and a receiver (not shown).

The IMU 104 comprises an accelerometer (not shown), a gyroscope (not shown), and any other suitable devices. The IMU 104 is configured to measure inertial measurement data, and provide said inertial measurement data to the processor 102. The inertial measurement data comprises acceleration data and angular velocity data. The acceleration data is representative of an acceleration of the wearer. The angular velocity data is representative of an angular velocity of the IMU 104. In optional embodiments, the device 100 further comprises a magnetometer (not shown) configured to provide magnetic field data.

The processor 102 is configured to periodically perform a calibration of the gyroscope of the IMU 104 according to the gyroscope calibration protocol discussed in the section titled “Gyroscope Calibration” below.

The second sensor 106 comprises a pressure sensor (not shown) and a temperature sensor (not shown). The second sensor 106 is configured to measure a pressure and an ambient temperature. The second sensor 106 is also configured to provide pressure data and ambient temperature data to the processor 102. The pressure data is representative of an air pressure of the environment in which the wearer is located. The ambient temperature data is representative of an ambient temperature of the environment in which the wearer is located.

The ANN of the present example is a residual convolutional neural network (RCNN). However, it will be appreciated that any suitable neural network architecture may be utilised. The RCNN comprises a combination of pool, convolutional, dense and other layer types. The RCNN also comprises one or more skip connections. Further detail regarding the architecture of the neural network can be found in the section titled “Artificial Neural Network Architecture” below. The RCNN is pre-trained. Further detail regarding the training process for the RCNN can be found in the section titled “Data Collection and Training” below. The RCNN is configured to be run on the dedicated neural processing unit 108, or a tensor processing unit (not shown) at a rate of 20 Hz. The skilled person will appreciate that the RCNN may be run at any suitable rate.

The position tracking device 100 is in communication with a remote device 110 located remote from the position tracking device 100. The remote device 110 is configured to receive data from the processor 102. The remote device 110 may be accessed by a user such that the user may retrieve real-world 3D position data of the wearer.

Notably, the position tracking device 100 is self-contained and does not rely on a connection to the remote device 110. Further, the position tracking device 100 is tolerant of a poor connection to the remote device 110 and can operate as normal if there is no connection to the remote device 110. The remote device 110 functions as a client, and subscribes to information provided by the tracking device 100 which may or may not transmit data to the remote device 110, such as configuration data, and/or ground truth pressure updates.

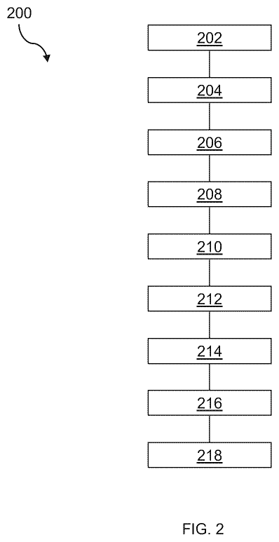

In use, the processor 102 is configured to perform a position tracking method 200, depicted in FIG. 2. In particular, FIG. 2 shows a flow diagram of the position tracking method 200 the position tracking device 100.

In a first step 202 of the method 200, the processor 102 collects inertial measurement data from the IMU 104. In the present example, the processor 102 is configured to collect inertial measurement data over a period of 1 second from the IMU 104 at 200 Hz, such that 200 data points are collected. Each data point comprises data corresponding to three accelerometer axes and three gyroscope axes. That is, each data point comprises an x axis accelerometer component, a y axis accelerometer component, a z axis accelerometer component, an x axis gyroscope component, a y axis gyroscope component, and a z axis gyroscope component.

At step 204, the processor 102 rotates the inertial measurement data into a world coordinate frame, the world coordinate frame being a real-world position in 3D space. In particular, the processor rotates the data points into a world coordinate frame using an Attitude and Heading Reference System (AHRS). The processor 102 determines an angular position by integrating an angular velocity over a time period. The processor 102 applies a continual correction in x and y coordinates of the angular position, using measurements of acceleration so as to remove gyroscope reading errors that may otherwise cause pitch and roll to deviate over time. The integration and correction are both applied every time a reading is available. In an example, a reading frequency is 200 Hz.

Notably, yaw may still be subject to deviation over time due to gyroscope reading errors. Minimisation of the yaw deviation may be achieve using an online continuous calibration process, and may be further minimised using a magnetometer.

At step 206, the processor 102 inputs the rotated inertial measurement data into the ANN. In an example, an input to the ANN is a 200 by 6 array of inertial measurement data, the inertial measurement data comprising the data corresponding to the three accelerometer axes and the three gyroscope axes. Accordingly, the ANN comprises 200 input nodes in the present example.

At step 208, the ANN outputs an average velocity of the time period, the time period being the one second of inertial measurement data collection. The velocity comprises an x-axis velocity component, a y-axis velocity component, and a z-axis velocity component, such that the velocity is in three dimensions. A second time period may overlap a first time period, such that the ANN outputs an average velocity more than once per time period.

At step 210, the processor 102 converts the velocity to a real-world location or position. In particular, the processor 102 integrates the 3D velocity over time to provide a real-world 3D position having an x value, a y value, and a z value, (x, y, z). The real-world 3D position is relative to a starting position, having dimension values of (0, 0, 0). In the present example, the time value is 1 second. Although the data is sampled over a time period of 1 second, the time value for purposes of integration may be less than 1 second since the ANN may run more than once per time interval.

At an optional step 212, the processor 102 collects pressure data and ambient temperature data from the second sensor 106. This step may occur simultaneously to step 202, and may occur several times over the collection period of step 202, such that the pressure data and the ambient temperature data corresponds to the inertial measurement data.

At a further optional step 214, the processor 102 determines an altitude value based on the pressure data and the ambient temperature data. In particular, the processor 102 utilises the known hypsometric formula to determine an altitude of the wearer using the pressure data and the ambient temperature data.

At a further optional step 216, the processor 102 modifies a vertical, or z, value of the real-world 3D position based on the determined altitude value. Therefore the real-world 3D position includes the x value, y value, and modified z value. The vertical position is determined using a state estimator which combines pressure data, temperature data, accelerometer data, and the output of the ANN.

At step 218, the processor 102 transmits data representative of the real-world 3D position to the remote device 110.

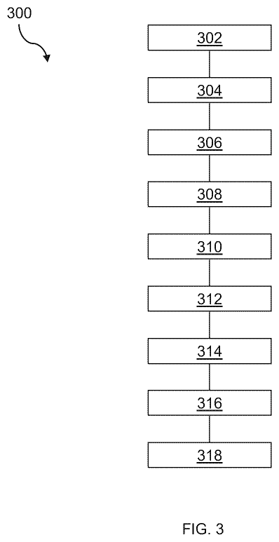

In use, the processor 102 is also configured to perform a stance determination method 300, depicted in FIG. 3. In particular, FIG. 3 shows a flow diagram of the stance determination method 300 using the position tracking device 100.

In the stance determination method 300, the processor 102 determines a stance and/or activity information of the wearer. In particular, the processor 102 determines the stance as the wearer performing one of: walking, crawling, standing, running, climbing, and/or any other suitable action. The processor 102 also determines activity information indicative of freefall events, or periods of high activity, wherein ‘high activity’ is defined as highly dynamic motion having no significant forward, or horizontal, progress or movement. The processor 102 determines the stance and activity information based on: an average velocity over a preceding period; an average acceleration over a preceding period; an average rotation over a preceding period; and device orientation and attitude in the real-world coordinate frame.

In a first step 302, the processor 102 collects inertial measurement data from the IMU 104. In the present example, the processor 102 is configured to collect 1 second of inertial measurement data from the IMU 104 at 200 Hz, such that 200 data points are collected. Each data point comprises data corresponding to three accelerometer axes and three gyroscope axes. That is, each data point comprises an x axis accelerometer component, a y axis accelerometer component, a z axis accelerometer component, an x axis gyroscope component, a y axis gyroscope component, and a z axis gyroscope component.

At step 304, the processor 102 rotates the inertial measurement data into a world coordinate frame, the world coordinate frame being a real-world position in 3D space. In particular, the processor rotates the data points into a world coordinate frame using an Attitude and Heading Reference System (AHRS).

At step 306, the processor 102 inputs the rotated inertial measurement data into the ANN. In particular, the input to the ANN is a 200 by 6 array of inertial measurement data, the inertial measurement data comprising the data corresponding to the three accelerometer axes and the three gyroscope axes. Accordingly, the ANN comprises 200 input nodes in the present example.

At step 308, the ANN outputs an average velocity of the time period, the time period being the one second of inertial measurement data collection. The velocity comprises an x-axis velocity component, a y-axis velocity component, and a z-axis velocity component, such that the velocity is in three dimensions.

The skilled person will appreciate that steps 302 to 308 of the method 300 correspond to steps 202 to 208 of the method 200. Accordingly, the method 300 may occur simultaneously to the method 200.

At step 310, the processor 102 determines an average acceleration of the time period based on the acceleration data captured over the time period.

At step 312, the processor 102 determines an average rotation rate of the time period. The processor 102 determines the average rotation rate by determining a mean average value of the gyroscope readings over the time period. The processor 102 may maintain a sufficiently large internal buffer to be averaged when required. The processor 102 may alternatively maintain a rolling average which can be polled at any instant without requirement for further computation. Alternative methods may include integrating the rotation rate over the time period, then dividing by the time period, or more advanced digital signal processing techniques.

At step 314, the processor 102 determines a device orientation and attitude in the world coordinate frame. The processor 102 determines the device orientation and attitude by integrating an angular velocity over a time period. The processor 102 applies a continual correction in x and y coordinates of the angular position, using measurements of acceleration so as to remove gyroscope reading errors that may otherwise cause pitch and roll to deviate over time. The integration and correction are both applied every time a reading is available. In an example, a reading frequency is 200 Hz.

At step 316, the processor 102 determines the stance and activity information of the wearer. In the present example, the stance is determined based on a time period of 1 second, whereas the activity information is determined based on a time period of 100 milliseconds.

At step 318, the processor 102 transmits the stance and activity data to the remote device 110. In the present example, the stance and activity data further comprises a time value representative of a start and end time at which the inertial measurement data was recorded.

Steps 218 and 318 of the methods 200 and 300 may occur simultaneously. The position data, stance data, activity data, and other metadata is communicated to the remote device 110 using a low power long range radio (not shown) in communication with the processor 102. For example, the radio transmits at 10 bytes per second, wherein six bytes are reserved for position data (each ordinate is encoded as a 16-bit integer), with the remainder being reserved for the stance data, activity data, and other metadata.

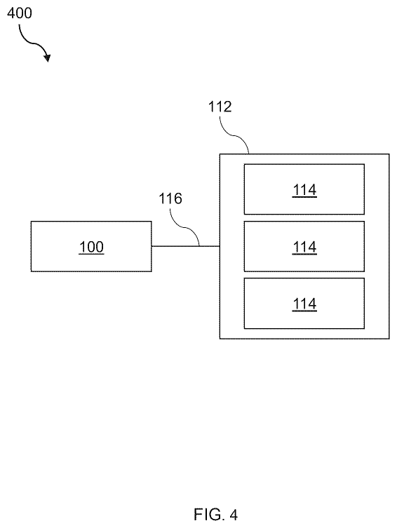

FIG. 4 shows a systematic view of a position tracking system 400 comprising the position tracking device 100 in communication with a network of nodes 112, in accordance with a second aspect of the present disclosure.

The position tracking device 100 is in communication with the network of nodes 112 via an ultra-wideband (UWB) radio communication means 116. The device 100 and the network of nodes 112 form the position tracking system 400.

The network of nodes 112 comprises a plurality of nodes 114, wherein the position tracking device 100 acts as a node of the network of nodes 112. The plurality of nodes 114 are geographically distributed. The network of nodes 112 is self-mapping. Further detail regarding this self-mapping is discussed in the “Network Self-mapping” section below.

The remote device (not shown in FIG. 4) may also be present in the position tracking system 400, and may act as an additional node 114 of the plurality of nodes 114. Using the remote device as a node 114 provides a fixed, known, stationary node, which can be used to augment mapping performance.

### Network Self-Mapping

The network of nodes 112 is self-mapping and comprises the plurality of nodes 114, each with a central processor comprising an iterative solver. Each node 114 serves as a distributed compute resource and each node 114 stores a copy of a node map (i.e. geographical distribution of nodes) for redundancy and resilience. One or more nodes 114 may be directly connected to control and monitoring software on a supported platform by USB, or by non-participating nodes. The nodes 114 may be placed anywhere, such as fixed to walls, or placed on table tops and/or shelves within buildings. The nodes 114 comprise batteries (not shown) appropriate to the expected life of the installation.

The central processors of each node 114 are configured to initialize the network 112 by assigning each respective node 114 a random geographical position. The random geographical position may be in the form of a GPS coordinate. The random geographical positions of the nodes 114 are evolved over time by means of an optimization algorithm, and those positions are herein referred to as ‘estimated positions’.

The plurality of nodes 114 are also configured to execute a map optimisation algorithm. When deployed, the plurality of nodes 114 may automatically communicate with each other via an ultra-wideband (UWB) communication means, such as the UWB communication means 116. The plurality of nodes 114 measure pairwise ranges between respective node pairs in the network 112 using the UWB communication means, and use that information to create a map of their relative locations. There are no special nodes, meaning there is no distinction between anchors and tags as there might be in other UWB mapping systems. Any node 114, or multiple nodes 114, can be moved at any time to a new geographic position. The map generation process is iterative and updates in real time.

In particular, the network of nodes 112 may be modelled as a damped, fully-connected spring network. Each node pair may be connected by a respective ‘network spring’ (not shown). A true length of the network spring is variable and defined as a true distance between the node pair. The true distance between a node pair is the distance as determined by UWB range exchanges. An estimated length of the network spring is variable and defined as an estimated distance between the node pair, more particularly as the current distance between the node pair as determined by the central processors of the node pair based on the estimated positions. The estimated distance may be determined by any estimation means. Initially, the estimated positions are the estimated positions assigned when the network 112 is initialised, although the estimated positions are updated.

A network spring tension in each network spring connecting a pair of nodes 114 is a function of the difference between its true length and estimated length. Nodes acquire velocity by accelerating in response to the network spring tension, wherein a greater difference between the true length and the estimated length corresponds to a greater acceleration. Network springs are straight and can exert force in either direction, to bring nodes 114 closer together or further apart on the network map.

Each network spring has an associated network spring coefficient. The network spring coefficient is a function of the connection quality between a pair of nodes 114. In particular, network springs which correspond to weak connections have low network spring coefficient, so they contribute less to the dynamics of the network 112. The network 112 is therefore dominated by network springs with higher network spring coefficients. That is, the network 112 is dominated by nodes 114 having a high connection quality.

Each node 114 has a node mass which is a function of a motion state of the nodes 114 on the network map, as determined by an accelerometer (not shown). Nodes 114 which are known to be stationary have high node mass and therefore high node inertia. Nodes 114 which are known to be mobile have a lower node mass and therefore a lower node inertia than the stationary nodes. This prevents network springs attached to known mobile nodes unduly altering the position of the known stationary nodes on the network map. Low node mass (i.e. mobile) nodes are more easily moved by connected network springs.

Network spring oscillations are damped to minimise oscillations of the spring network; an undamped network would never settle as energy is conserved (only approximately, since masses can change). The network 112 starts with a predetermined amount of potential energy which is converted to kinetic energy and depleted over time by the damping. Energy is added to the system as nodes 114 move and introduce additional tension into the network springs, allowing further evolution of the network 112.

As nodes 114 approach their optimal positions, network spring tensions in the spring network reduce, residual velocity is damped out, and the network 112 comes to rest, and a map is generated. The network 114 requires no existing infrastructure to generate this map.

When a new node 114 joins the network 112, the central processors update the map.

A map determined by the central processors can reach a ‘stuck’ state. Like all iterative optimisation algorithms, it is possible for the map to reach a non-optimal solution and be unable to evolve further. This is managed by defining concepts of network loss and network momentum.

Network momentum is the time derivative of network loss. Network loss defines how ‘wrong’ the current solution is, based on how much the true distance between node pairs 114 disagree with the estimated distance. Network loss is made scale-invariant by considering the number of nodes 114 in the network 112 and the distribution of distances between them. If network loss is high but network momentum is low, meaning the network 112 has not found the correct solution but has stopped evolving, the central processors perturb the network 112 until an improved solution is reached.

There are certain map symmetries which are impossible to eliminate using only range information. The solution will be rotated relative to the real world and may also be reflected relative to the real world. These are called degenerate solutions—they are indistinguishable as far as the map optimisation algorithm is concerned. Some of the rotational symmetries may be eliminated by using a pressure sensor (not shown) in each node 114 to determine its altitude. Remaining rotational symmetries may be manually corrected using control software. Reflection symmetry can be eliminated by either manual input of approximate positions or manual reflection using the control software. The positions of each node may be approximate, and the network 112 may apply corrections to the node positions over time. It is then much less likely that the network will reach any stuck state before finding the true solution.

It is not necessary for the network 112 to accurately track real clock time; it only needs to be monotonically increasing. Clock synchronization meeting this condition is easily achieved by including the local device time of a node 114 in each message transmitted by the node.

The nodes 114 transmit and receive a variety of messages, including: range measuring messages; handshake and discovery messages; map sharing messages; and additional messages for sharing configuration and scheduling information. All messages except range measuring messages include the local time of the node 114 which transmitted the message. Receiving nodes 114 may adjust their clocks in response to maintain synchronization across the network 112.

The range measuring message may comprise information usable to determine the true distance and/or the estimated distance between a respective node pair.

The handshake and discovery messages are transmitted when a first node is powered on. A first node which is not a member of the network 112 will wait to receive a transmission from that network 112. If no messages are received within a predetermined time period, the first node will deduce that the network 112 is not yet active and will enter a normal operating mode. The normal operating mode in the present example comprises sending a periodic discovery message. Any second nodes which join subsequently will receive the discovery message during a discovery phase, and will handshake with the first node. The first node and the second node will start sending range measuring messages to each other.

The central processor of each node 114 independently computes a map, and the nodes 114 share their maps by transmitting the map sharing messages, in order for the network 112 as a whole to reach a more optimal solution. For example, a single node 114 may have a substantially incorrect map, which can be corrected if a majority of nodes 114 transmit a map sharing message comprising a substantially correct map.

Each node 114 of the plurality of nodes 114 has a node time. When a message is received at a receiving node of the plurality of nodes 114 from a transmitting node of the plurality of nodes 114, the receiving node will keep its node time or adopt a message time of the received message if the message time is more than 1 ms later than the node time. If the message time is earlier or identical to local time, no change is made. The time is guaranteed to propagate through the network 112 of n nodes 114 in at most n hops or communications. This corresponds to the worst case in which the nodes 114 are connected in a straight line such that communication is sequential, and time must propagate from one end of the network 112 to the other. Local time in this context is the time reported by the internal clock of the node 114. It is ‘local’ to that node 114. The local time may be dependent on the time elapsed since the node 114 was powered on. Each node 114 maintains its own local time, which may be modified in order to synchronize clocks with the rest of the network 112.

A disconnected subnetwork of the network 112 cannot be synchronized. However, the disconnected subnetwork will be synchronized with the network 112 if it connects to the network 112. However, this is not an issue for the present system because a disconnected subnetwork cannot be used for mapping regardless of clock synchronization.

The network 112 scheduling can tolerate clock disagreements between nodes 114 of up to 1 ms without risk of transmission collisions. Once clock synchronization is achieved, each node 114 will independently compute a schedule which dictates when it is allowed to send certain kinds of messages, and when it should expect to receive certain kinds of messages. This schedule depends on an identity number of the node 114, so will be different for each node 114. Importantly, no two nodes 114 in a correctly configured network 112 will ever attempt to transmit a message at the same time. This schedule eliminates the possibility of overlapping transmissions which could block messages from being received.

Whenever a clock adjustment is made at a particular node 114, the node 114 will wait a full schedule cycle (on the order of 1 second) before transmitting any more messages.

### Gyroscope Calibration

Over time, a bias of the gyroscope of the IMU 104 may change, leading to an error in angular rate measurements.

In order to account for this bias change, the processor 102 automatically re-calibrates the gyroscope when the wearer is stationary.

The processor 102 detects the stationary state based on an acceleration magnitude and a rotational magnitude. In particular, the processor compares an acceleration, as provided by the accelerometer of the IMU 104, with the Earth's gravitational acceleration. If the acceleration is within a threshold value of the Earth's gravitational acceleration, and the rotational magnitude is within a threshold value of zero for a predetermined period of time, the processor 102 detects that the wearer is stationary.

When the processor 102 detects a stationary state of the wearer, the processor 102 samples the gyroscope. The processor 102 adjusts the bias calibration by an exponentially-weighted moving average (EWMA):

bias=(1−weight) * old_bias+weight* new_bias

The processor 102 is also configured to actively correct a heading of the IMU 104. In particular, the processor 102 is configured to determine that the device 100 is within a communication range of at least one node 114 of the network 112. The processor is configured to determine, or measure, a distance between the wearer or device 100 and the node 114 using the UWB communication means 116. The processor 102 determines the real distance by means of UWB radio transmissions via the ultra-wideband radio communication means 116, using a method such as two-way ranging (TWR), or time difference of arrival (TDOA). Additional distance determination methods will be known to the skilled person.

The “real distance” is distinct to the “estimated distance” according to the position determined by the processor 102. Notably, the real distance is subject to error and as such, error management methods may be employed. Estimated distance is determined by the processor 102 based on the position of the wearer, determined in step 210, at the time the position tracking device 100 was deployed, and subsequent estimated motion of the wearer.

The processor 102 repeats the heading correction process whenever the wearer is determined to be in range of a beacon.

The iterative algorithm is as follows:
1. Set switch number =0
2. While switch number<[configurable]
   a. Evaluate pre-correction loss
   b. Propagate small heading correction
   c. Evaluate post-correction loss
   d. If post-correction loss>pre-correction loss
   I. Undo correction
   II. Change sign of correction factor
   III. Reduce magnitude of correction factor
   IV. Increment switch number

The loss function differs depending on the use case. In the case of a pre-recorded closed path with no beacons, the loss is the separation between the start and end points. The algorithm iteratively minimises this distance. For live paths using a beacon to detect closed loops, the loss is the averaged squared error for position estimates produced while within a certain range of the beacon. The error is the absolute value of the difference between the true distance to the beacon and the estimated distance to the beacon. The correction factor is applied to the entire history of the path and to new parts of the path.

### Artificial Neural Network Architecture

An example artificial neural network (ANN) of the present disclosure is configured to receive, an input, a 200 by 6 array of inertial measurement unit (IMU) data. The ANN is also configured to output a 3 by 1 array of position data.

The ANN architecture comprises a series of distinct blocks comprising an input block, a first block type, a second block type, a third block type, and an output block.

The input block comprises a series of distinct layers comprising an input, a reshape, a convolution, a reshape, a ReLU; an unsqueeze, and a max pooling.

The first block type comprises a series of distinct layers comprising a squeeze, a reshape, a convolution, a reshape, a ReLU, a reshape, a convolution, a reshape, and an element wise sum. The first block type also comprises a residual connection between the squeeze and the element-wise sum.

The second block type comprises a series of distinct layers comprising a ReLU, a reshape, a convolution, a reshape, a ReLU, a reshape, a convolution, a reshape, and an element wise sum.

The second block type also comprises a residual connection between the first ReLU and the element-wise sum.

The third block type comprises a series of distinct layers comprising a ReLU, a reshape, a convolution, a reshape, a ReLU, a reshape, a convolution, a reshape, and an element wise sum. The second block type also comprises a residual connection between the first ReLU and the element-wise sum. The residual connection also comprises a reshape, a convolution, and a reshape.

The output block comprises a series of distinct layers comprising a ReLU, a reshape, a convolution, a fully connected layer, a ReLU, a fully connected layer, a ReLU layer, a fully connected layer, and an output layer.

The ANN architecture is composed in the following configuration:
1. Input block
2. First block type
3. 2×Second block type
4. Third block type
5. 3×Second block type
6. Third block type
7. 5×Second block type
8. Third block type
9. 2×Second Block type
10. Output block

### Data Collection and Training

The artificial neural network (ANN) is trained using ground truth data collected by means of a stereo camera. The stereo camera calculates position in three dimensions, and IMU data is recorded at the same time. Each 1-second sample of IMU data is labelled with the speed inferred from the stereo camera at the corresponding or matching time stamp. This labelled IMU data is used to train the ANN.

The particular stereo camera used is a stereo camera as is well known in the industry. The skilled person will understand that any device suitable for facilitating calculation of a three-dimensional position may be used. The stereo camera of the present disclosure outputs position data, estimated error data, and other related data at 60 Hz. The device's self-reported uncertainty is used to cull periods of low-quality data from the training set. The output is interpolated to 200 Hz. The position data is differentiated in order to determine corresponding velocity data, and this velocity is used to label the IMU data used to train the ANN.

To enrich the dataset, each labelled IMU data sample is randomly rotated around a vertical axis in the real-world coordinate frame, to produce additional data samples.

The description provided herein may be directed to specific implementations. It should be understood that the discussion provided herein is provided for the purpose of enabling a person with ordinary skill in the art to make and use any subject matter defined herein by the subject matter of the claims.

It should be intended that the subject matter of the claims are not limited to the implementations and illustrations provided herein, but include modified forms of those implementations including portions of implementations and combinations of elements of different implementations in accordance with the claims. It should be appreciated that in the development of any such implementation, as in any engineering or design project, numerous implementation-specific decisions should be made to achieve a developers' specific goals, such as compliance with system-related and business related constraints, which may vary from one implementation to another. Moreover, it should be appreciated that such a development effort may be complex and time consuming, but would nevertheless be a routine undertaking of design, fabrication, and manufacture for those of ordinary skill having benefit of this disclosure.

Reference has been made in detail to various implementations, examples of which are illustrated in the accompanying drawings and figures. In the detailed description, numerous specific details are set forth to provide a thorough understanding of the disclosure provided herein.

However, the disclosure provided herein may be practiced without these specific details. In some other instances, well-known methods, procedures, components, circuits, and networks have not been described in detail so as not to unnecessarily obscure details of the embodiments.

It should also be understood that, although the terms first, second, etc. may be used herein to describe various elements, these elements should not be limited by these terms. These terms are only used to distinguish one element from another. For example, a first element could be termed a second element, and, similarly, a second element could be termed a first element. The first element and the second element are both elements, respectively, but they are not to be considered the same element.

The terminology used in the description of the disclosure provided herein is for the purpose of describing particular implementations and is not intended to limit the disclosure provided herein. As used in the description of the disclosure provided herein and appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify a presence of stated features, integers, steps, operations, elements, and/or components, but do not preclude the presence or addition of one or more other features, integers, steps, operations, elements, components and/or groups thereof.

While the foregoing is directed to implementations of various techniques described herein, other and further implementations may be devised in accordance with the disclosure herein, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A localisation device comprising:
a first sensor configured to provide first measurement data;
a neural processing unit (NPU) comprising a pre-trained artificial neural network (ANN);
and
a processor in communication with the first sensor and the NPU, the processor configured to:
collect first measurement data from the first sensor over a time period; and
determine a real-world location using the ANN.

2. The device of claim 1, wherein the first sensor is an inertial measurement unit (IMU) comprising an accelerometer and a gyroscope, the IMU being configured to measure an acceleration and an angular velocity; wherein the first measurement data comprises:
acceleration data; and
angular velocity data.

3. The device of claim 1, wherein the processor determines the real-world location by:
rotating the first measurement data into a world coordinate frame;
inputting the rotated first measurement data into the ANN;
receiving an average velocity of the time period from the ANN; and
converting the average velocity to a real-world location.

4. The device of claim 1, further comprising a second sensor configured to measure a pressure and a temperature, wherein the processor is further configured to:
receive pressure data and temperature data from the second sensor;
determine an altitude value based on the pressure data and the temperature data; and
modify a vertical component of the real-world location based on the altitude value.

5. The device of claim 4, wherein the altitude value is determined using a hypsometric formula.

6. The device of claim 1, wherein the processor is further configured to determine a stance of a wearer based on the first measurement data.

7. The device of claim 6, wherein the processor is configured to determine the stance of the wearer based on first measurement data captured over a stance time period.

8. The device of claim 1, wherein the processor is further configured to determine activity information of a wearer based on the first measurement data.

9. The device of claim 8, wherein the processor is configured to determine the activity information of the wearer based on first measurement data.

10. The device of claim 2, wherein the processor is further configured to:
detect a stationary state of the device; and
adjust a bias calibration parameter of the gyroscope.

11. The device of claim 10, wherein the processor is configured to utilise an exponentially-weighted moving average (EWMA) to adjust the bias calibration parameter of the gyroscope.

12. The device of claim 1, wherein the processor is further configured to transfer data to a remote server via a communication means.

13. The device of claim 1, wherein the ANN is trained using ground truth data comprising 3D position information.

14. A localisation system comprising:
the device of claim 1; and
a network of nodes comprising one or more processors;
wherein the device is a node of the network of nodes; and
wherein the network of nodes is configured to generate a node map.

15. The system of claim 14, wherein the network of nodes generate the node map via an iterative process that updates in real-time.

16. The system of claim 14, wherein the node map is modelled as a damped, fully-connected spring network, wherein the node map is initially modelled by assigning each node a random geographical location.

17. The system of claim 14, wherein the node map is updated when a new node connects to the network of nodes.

18. The system of claim 14, wherein the processor is configured to:
determine that the device is within a communication range of a node of the network of nodes;
determine a distance between the device and the node;
estimate a distance between the device and the node using the first sensor;
determine a heading angle error of the gyroscope based on the determined distance and the estimated distance; and
alter the heading angle of the gyroscope by removing the heading angle error.

19. The system of claim 18, wherein the processor determines a distance between the device and the node using an ultra-wideband radio communication means.
